(19) United States
(12) Patent Application Publication
(10) Pub. No.: US 2003/0025731 A1
(43) Pub. Date: Feb. 6, 2003

(54) Method and system for automated research using electronic book highlights and notations

(75) Inventors: Alicia Anne Chastain, Raleigh, NC (US); Christopher Joseph Paul, Durham, NC (US); David Mark Wendt, Apex, NC (US)

Correspondence Address: A. Bruce Clay, IBM Corporation T81/503, PO Box 12195, Research Triangle Park, NC, 27709, US

(73) Assignee: International Business Machines Corporation, Armonk, NY

(21) Appl. No.: 09/921,020

(22) Filed: Aug. 2, 2001

(51) Int. Cl. G06F 3/00; G06F 13/00

(52) U.S. Cl. 345/764

(57) ABSTRACT

The present invention provides a method, apparatus, and computer implemented instructions for researching highlighted passages and/or notations in an electronic book. A user can highlight passages and/or notations in an electronic book, which are stored in a search profile and automatically researched utilizing commercial search engines invoked with profile criteria. The results from the search engines are evaluated based on search criteria so that the most relevant Web sources and sites are identified.

### FIELD OF THE INVENTION

The present invention relates generally to an improved data processing system for processing data. Still more particularly, the present invention relates to the automated searching of highlighted passages and notations in an electronic book.

### BACKGROUND OF THE INVENTION

The Internet, also referred to as an “internetwork”, is a set of computer networks, possibly dissimilar, joined together by means of gateways that handle data transfer and the conversion of messages from protocols of the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies, which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The Internet also is widely used to transfer applications to users using browsers. With respect to commerce on the Web, individual consumers and business use the Web to purchase various goods and services. In offering goods and services, some companies offer goods and services solely on the Web while others use the Web to extend their reach. Many sources of information are available on the Web, including electronic books and journals. The demand and need to gather information quickly is increasing as technology advances. The Web with the use of various commercial search engines is used to research information on virtually any topic.

When using an electronic book, referred to as an “e-book”, a user may see information or passage of interest. Often times the user may want to perform research on topics or items presented in the e-book. The ability to further research this information is desired. E-books may contain large amounts of text. When researching information from an e-book, referring back to the portions of text that are of interest may be cumbersome and time consuming due to the size of the electronic book. This is especially true if the user has found multiple items of interest in different potions of the e-book. Currently, a user has to retype text from the passages on a Web page for a search engine to initiate a search. Alternatively, the user may copy and paste text from the e-book into the Web page for the search engine. Both require referring back and forth between the e-book and the search engine interface. This also requires the user to remember where the items of text are located within the e-book.

Therefore, it would be advantageous to have an improved method, apparatus, and computer instructions for researching information found in an e-book.

### SUMMARY OF THE INVENTION

The present invention provides a method, apparatus, and computer implemented instructions for researching highlighted passages and notations in an electronic book. A user can highlight passages and/or notations in an electronic book, which are stored in a search profile and automatically researched utilizing one or more search engines invoked with profile criteria. The results from the search engines are evaluated based on search criteria so that the most relevant Web sources and sites are identified.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in which the present invention may be implemented;

FIG. 3 is a block diagram illustrating a data processing system in which the present invention may be implemented;

FIG. 4 is a block diagram of a search process for electronic books in accordance with a preferred embodiment of the present invention;

FIG. 5 is a diagram of an electronic book with a pop-up window displaying the option to research the current note according to the present invention;

FIG. 6 is a flowchart of the process of maintaining a search profile to research highlighted passages from an electronic book in accordance with a preferred embodiment of the present invention;

FIG. 7 is a flowchart of the process of researching highlighted passages from an electronic book in accordance with a preferred embodiment of the present invention; and

FIG. 8 is a flowchart of the process of using a search profile to return results from a search engine in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

A user located at client, such as client 108, may view an e-book or some other electronic document using an e-book program or a browser. The present inventions allows the user to select or highlight portions of the e-book or document and have a search initiated on those portions. The search is sent to a server, such as server 104. Results are returned to the user at client 108 for review.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

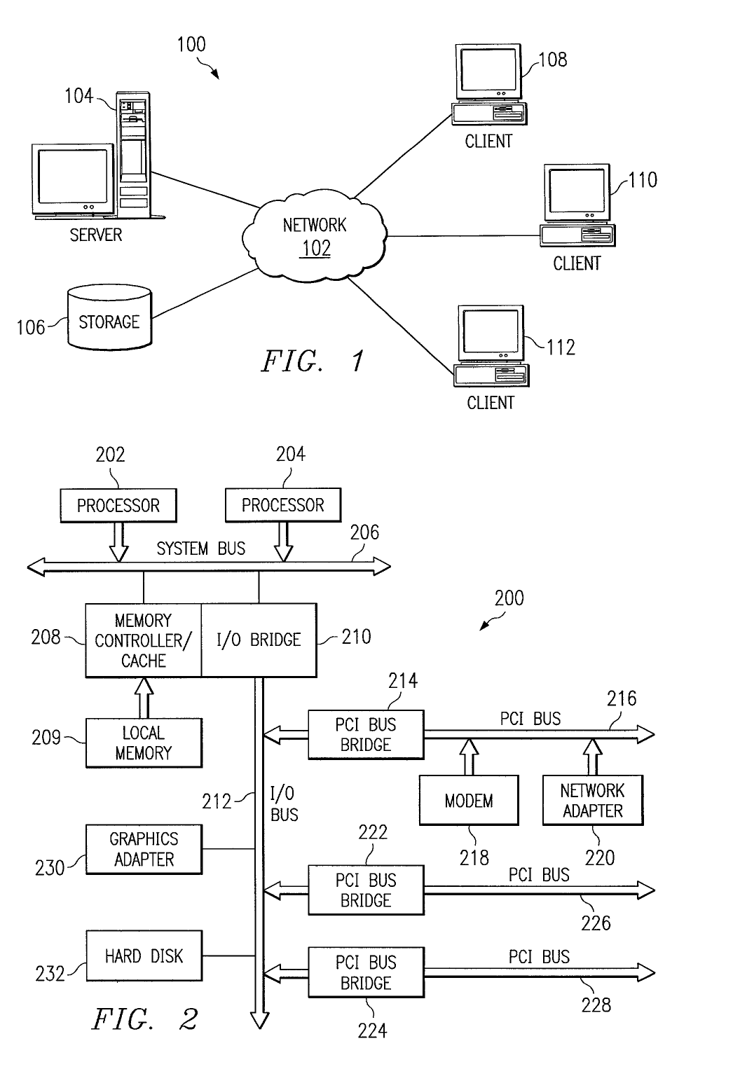

Referring to FIG. 2, a block diagram of a data processing system that may be implemented as a server, such as server 104 in FIG. 1, is depicted in accordance with a preferred embodiment of the present invention. Server 200 is an example of a data processing system in which a search engine may be located. Server 200 receives a search request from a client, such as client 108 in FIG. 1 and returns a result.

Server 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

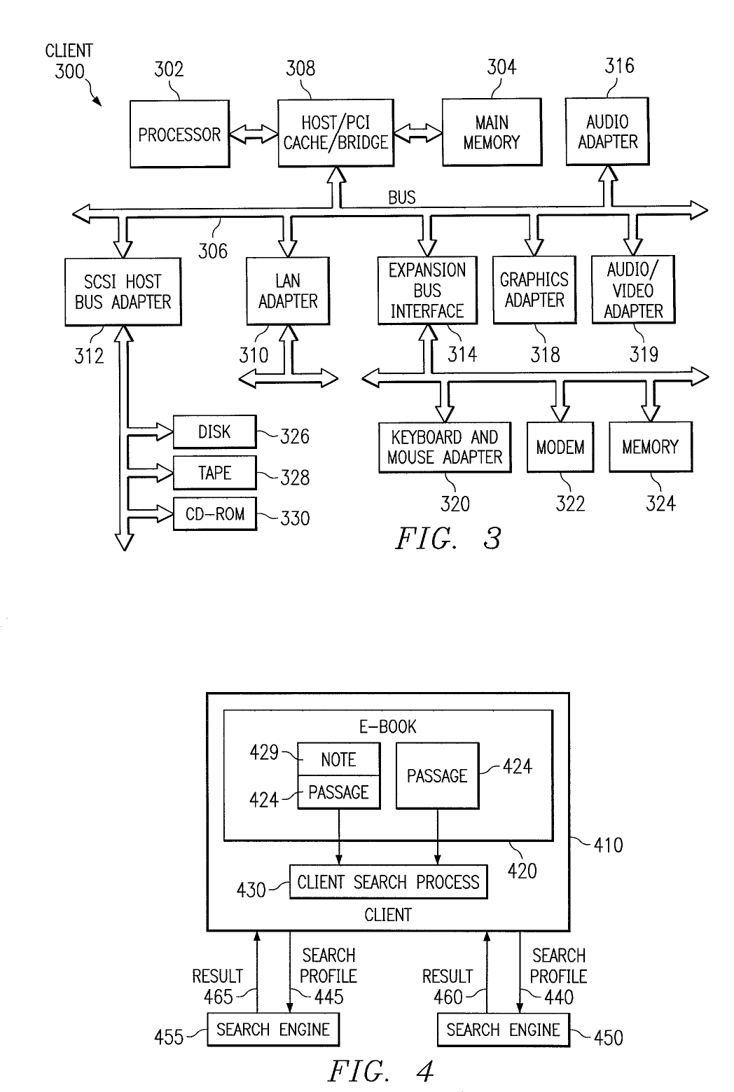

With reference now to FIG. 3, a block diagram illustrating a data processing system is depicted in which the present invention may be implemented. Data processing system 300 is an example of a client computer. Client 300 may include appropriate programs for viewing e-books or other electronic documents. Client 300 also includes the processes of the present invention for viewing an e-book, highlighting or otherwise selecting a portion of text, send the text to a search engine for searching, receive the results, and present them to the user.

Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide nonvolatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Turning next to FIG. 4, a block diagram of a client search process for electronic books in accordance with a preferred embodiment of the present invention. Client 410 may be used to display e-book 420. A user can highlight or select passages 424 and 428 within e-book 420, which may be researched using client search process 430. A note, such as note 429, may be associated with a passage, such as passage 428. These passages are placed into search profile 440. The tagging of the highlighted passage for searching may be initiated using a number of different mechanisms. For example, the user may press a function button or select a command from a menu then highlight the passage that is to be searched. The passage may be highlighted first and then a function or command may be used to initiate the searching. A user may designate multiple passages for searching. This note also may be tagged for research in these examples. Alternatively, a note may be used in research without a highlighted passage. These notes may contain text, such as comments about the passage or may contain other information. For example, a note may contain references that relate to the passage. The reference may refer to anything about the text, such as, for example, a book title, author, publisher, publication date, ISBN number, section, chapter, page, paragraph, topic, subject, or category. Other information, that may be included in a note, are for example, a user name, career field, interests, and other books being researched.

Search criteria, such as for example the subject and author of the book, are included in search profile 440 and search profile 445 by client search process 430. The search criteria are sent to search engines 450 and 455 to research highlighted passage 424. When a search engine is invoked with the search profile criteria, the search engine will evaluate items for relevance to the selected highlighted passage and/or notes. This evaluation could be done by a simple word count in the returned Web page to identify most relevant sites or by other user specified methods. For example, the user could choose to give higher relevance to items from a Web source originating from an educational institution. Results 460 and 465 are returned to client 410 from search engines 450 and 455.

The components illustrated in FIG. 4 have been presented for purposes of illustrating one embodiment of the present invention and are not meant to be limiting to the manner in which the processes of the present invention may be implemented. For example, client search process 430 may be implemented within e-book 420 rather than as a separate component. The processes in client search process 430 may alternatively be a plug-in for use in a browser if the processes for selecting and searching text are implemented for use with Web pages.

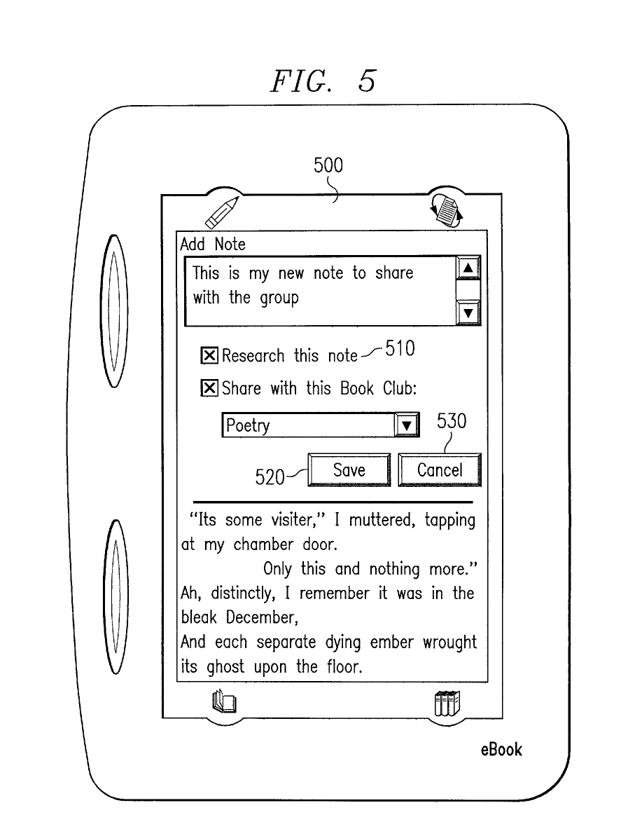

FIG. 5 is a diagram of an electronic book with pop-up window 500 displaying the option to research the current note according to the present invention. The user can mark box 510 if the note is to be researched. The user may choose to click on save button 520 to save the note and tag the note to be researched if box 510 is marked. Otherwise, the user may choose to click on cancel button 530 if the note is not to be saved.

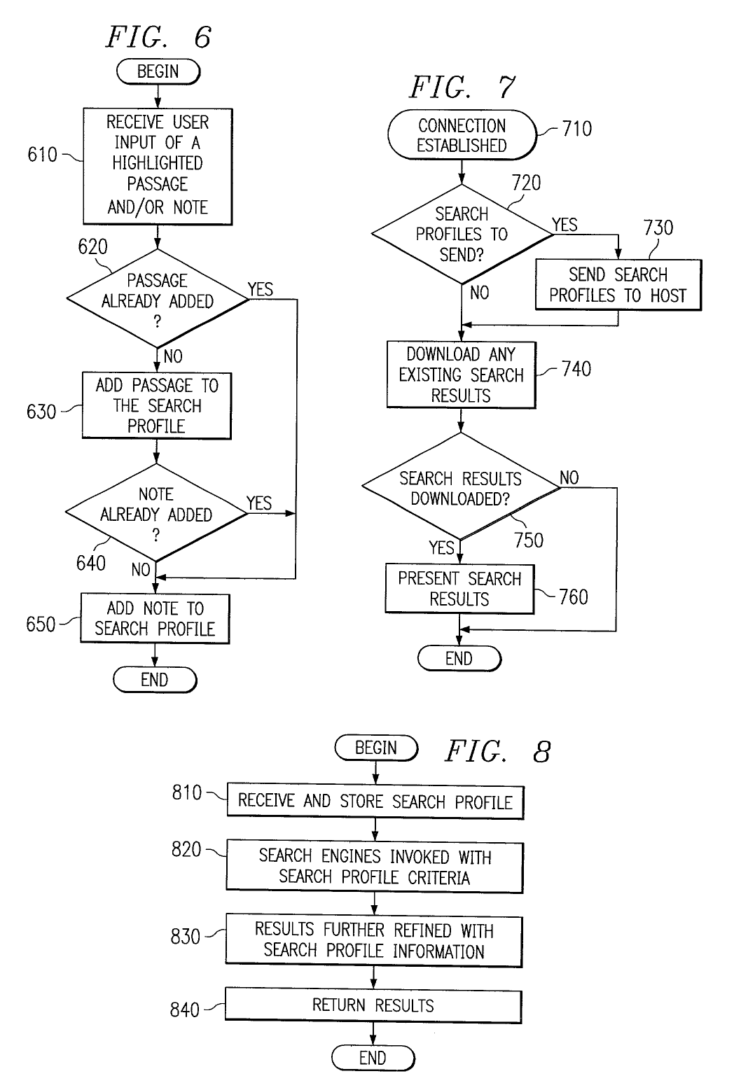

FIG. 6 is a flowchart of the process of generating a search profile, such as search profiles 440 and 445 in FIG. 4, to research highlighted passages and/or notes from an electronic book in accordance with a preferred embodiment of the present invention. The process illustrated in FIG. 6 may be implemented in a client search process, such as client search process 430 in FIG. 4.

The process begins by receiving a user input designating a highlighted passage and/or note for searching (step 610). A determination is made as to whether the highlighted passage is already within the search profile (step 620). If the highlighted passage is not included in the search profile, the highlighted passage is added to the search profile (step 630). A determination is made as to whether the notes are already within the search profile (step 640). If the notes associated with the highlighted passage are not included in the search profile, the notes are added to the search profile (step 650) with the process terminating thereafter. Turning back to step 640, if the notes associate with the highlighted passage are already included in the search profile, the process proceeds to step 650. With reference again to step 620, if the passage has already been added, the process also proceeds to step 650.

Next, FIG. 7 is a flowchart of the process of researching highlighted passages from an electronic book in which the present invention may be implemented. The process illustrated in FIG. 7 may be implemented in a client search process, such as client search process 430 in FIG. 4.

The highlighted passages or notes are automatically researched by invoking search engines through the use of the Internet as discussed in FIG. 1. The process begins by detecting a connection to the Internet (step 710). In response to detecting a connection, a determination is made as to whether search profiles are present to send to an Internet host for searching (step 720). If search profiles exist, the search profiles are sent to the Internet host (step 730). Any existing search results may be downloaded (step 740). A determination is made as to whether search results were downloaded (step 750). If search results were downloaded, the search results are presented to the user (step 760) with the process terminating thereafter. Turning back to step 750, if the search results are not downloaded, the process terminates. With reference again to step 720, if the search profiles are not present, the process proceeds to step 740 as described above.

FIG. 8 is a flowchart of the process of using a search profile to return results from a search engine in which the present invention may be implemented. The process illustrated in FIG. 8 may be implemented by an Internet host or by a search engine. For example, the process may be implemented in search engines 450 and 455 in FIG. 4.

The process begins by receiving and storing the search profiles (step 810). Search engines, such as search engines 450 and 455 in FIG. 4, are invoked with the search profile criteria (step 820). The results are further refined with additional search profile information (step 830).

The refining may include using other subjects currently stored in an e-book. For example, a reader may have several e-books that that are being read. In an e-book, such as a biology book, passages may be highlighted about crystals' growth patterns and lattice structures. In another e-book, such as an astronomy or physics journal, highlights of research on plant studies being conducted in space may be selected. Taken individually, the highlighted passages would yield very different search results. However, searching on the combination of these highlighted passages could identify information more specific to the overall research topic, rather than the unique content specific to each book. Searching on the combination of the highlights may produce a result, such as for example a report that sites the growth of geometrically perfect crystals in space, which may have been undiscovered had the topics been exclusively researched.

The results of the research are returned (step 840) to the client, such as client 410 in FIG. 4, with the process terminating thereafter.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, CD-ROMs, and transmission-type media such as digital and analog communications links.

The description of the present invention has been presented for purposes of illustration and description, and is not intended to be exhaustive or limited to the invention in the form disclosed. Many modifications and variations will be apparent to those of ordinary skill in the art. For example, the depicted embodiment is described with respect to initiating searching of selected portions of text from an e-book. The mechanism of the present invention also may be applied to other types of electronic documents, such as for example, an email, a word processing document, and a Web page. The embodiment was chosen and described in order to best explain the principles of the invention, the practical application, and to enable others of ordinary skill in the art to understand the invention for various embodiments with various modifications as are suited to the particular use contemplated.

What is claimed is

1. A method in a data processing system for researching text in an electronic book, the method comprising:
receiving a user input selecting the text from the electronic book to form selected text; and
automatically initiating a search for at least one item relevant to the selected text in response to receiving the user input.

2. The method of claim 1, wherein at least one item is at least one of a Web page, a Web site, another electronic book, an electronic document, and a universal resource locator.

3. The method of claim 1 further comprising:
storing the selected text in a data structure.

4. The method of claim 2, wherein data structure is a search profile.

5. The method of claim 1, wherein the selected text is highlighted text.

6. The method of claim 5, wherein the highlighted text is text in a different color from unselected text, bolded text, and text with a different font type from unselected text.

7. The method of claim 5, wherein the highlighted text is a notated passage of text in the electronic book.

8. The method of claim 5, wherein the highlighted text is a highlighted passage of text in the electronic book.

9. The method of claim 1 further comprising:
receiving a result from the searching; and
presenting the result.

10. The method of claim 9, wherein the step of receiving a result is initiated using a search engine.

11. A method in a data processing system for searching text, the method comprising:
responsive to a designation of the text in an electronic document, placing the text in a data structure;
transmitting the data structure to a search engine; and
receiving results from the search engine.

12. The method of claim 11, wherein the data structure is a search profile.

13. The method of claim 12, wherein the search profile includes search criteria.

14. The method of claim 11, wherein the electronic document is an electronic book.

15. The method of claim 11, wherein the electronic document is a Web page.

16. The method of claim 11, wherein the designation of the text is made by highlighting the text in the electronic document.

17. A method in a data processing system for researching highlighted text in an electronic book, the method comprising:
receiving results of researched selected text;
downloading the results of researched selected text; and
displaying the results of researched selected text.

18. A data processing system for researching highlighted text in an electronic book, a data processing system comprising:
receiving means for receiving a user input selecting the text from the electronic book to form selected text; and
initiating means for automatically initiating a search for at least one item relevant to the selected text in response to receiving the user input.

19. A method in a data processing system for searching text, the method comprising:
responsive to a designation of the text in an electronic document, placing means for placing the text in a data structure;
transmitting means for transmitting the data structure to a search engine; and
receiving means for receiving results from the search engine.

20. A data processing system comprising:
a bus system;
a communication unit connected to the bus system;
a memory connected to the bus system, wherein the memory includes a set of instructions; and
a processing unit connected to the bus system, wherein the processing unit executes the set of instruction to receiving a user input selecting the text from the electronic book to form selected text; and automatically initiating a search for at least one item relevant to the selected text in response to receiving the user input.

21. A computer program product in a computer readable medium for researching highlighted text in an electronic book, the computer program product comprising:
first instructions for receiving a user input selecting the text from the electronic book to form selected text; and
second instructions for automatically initiating a search for at least one item relevant to the selected text in response to receiving the user input.
